(19) United States
(12) Patent Application Publication
(10) Pub. No.: US 2017/0331906 A1
(43) Pub. Date: Nov. 16, 2017

(54) METHOD AND APPARATUS FOR MANAGING INTERNET-OF-THINGS SERVICE

(71) Applicant: KOREA ADVANCED INSTITUTE OF SCIENCE AND TECHNOLOGY, Daejeon (KR)

(72) Inventors: JunKyun Choi, Daejeon (KR); Hyeontaek Oh, Daejeon (KR); Sanghong Ahn, Daejeon (KR); JinHong Yang, Daejeon (KR)

(21) Appl. No.: 15/453,583

(22) Filed: Mar. 8, 2017

(30) Foreign Application Priority Data
May 10, 2016 (KR) 10-2016-0056795

(51) Int. Cl. H04L 29/08; H04L 12/24

(52) U.S. Cl. CPC H04L 67/16; H04L 41/14; H04L 41/22

(57) ABSTRACT

An apparatus includes a visualization module that displays a user interface required for a user to use an IoT service registered in a server, a service management module that manages a causal relationship between events that generate the IoT service to form an IoT service chain, and a generation and an operation of a mashup service configured by coupling a plurality of events, a data management module that manages an external service used by the user or provided by IoT devices and data input from a gateway, an entity management module that manages the IoT devices, the IoT service, and a user terminal which are registered in the server based on the event and the data in conjunction with each other, and to control operations of the IoT devices based on the IoT service, and a gateway interface that communicates with the gateway connected to the IoT devices.

### BACKGROUND

The present invention relates to a method and an apparatus for enabling a user to manage services in an environment that Internet-of-things (IoT) services are operated in conjunction with each other.

This study was carried out as part of the information communication and broadcasting R & D projects of Ministry of Science, ICT and Future Planning department and Institute for Information & Communications Technology Promotion. [R0190-15-2027, Development of TII (Trusted Information Infrastructure) S/W Framework for High-Reliability Intelligence Ecosystem Creation]

As the number of IoT devices increases, users not only use each device independently, but also associate various devices with each other to create new services tailored to their needs. For example, a smart lighting service is created in conjunction with an illuminance sensor and a smart electric bulb by using If-This-Then-That (IFTTT).

In addition to creating a new service in conjunction with IoT devices, a service chain is formed in which one service is subsequently executed as a result of execution of another service.

As the number of IoT devices increases and the number of services related to the IoT devices increases, users are having difficulty managing each service.

Specifically, as the service chain is created, the services may be operated in undesired forms in terms of the user, or several services may have results opposite to each other.

However, in terms of the user, although the user may see the result of the incorrect execution of a service, it is difficult for the user to know which service operation has caused the result.

### SUMMARY

Embodiments of the present invention provide a method and an apparatus that show which services result in an execution result of an IoT service in order to solve the problems that services of an IoT service chain are operated in undesired forms or cause results opposite to each other.

One aspect of embodiments of the inventive concept is directed to provide an apparatus for managing an Internet-of-things (IoT) service. The apparatus includes a visualization module that displays a user interface required for a user to use an IoT service registered in a server, a service management module that manages a causal relationship between events that generate the IoT service to form an IoT service chain, and a generation and an operation of a mashup service configured by coupling; a plurality of events, a data management module that manages an external service used by the user or provided by IoT devices and data input from a gateway, an entity management module that manages the IoT devices, the IoT service, and a user terminal which are registered in the server based on the event and the data in conjunction with each other, and to control operations of the IoT devices based on the IoT service, and a gateway interface that communicates with the gateway connected to the IoT devices.

The service management module may include a mashup service manager that generates, registers and manages the mashup service, wherein, when a start event occurs, and transfers the registered mashup service to a service process queue manager, the service process queue manager that manages a service queue to be executed by a related event instance among the registered mashup services and to manage a mashup service generated first in time sequence to be executed, a context repository that stores the causal relationship between the events, and a context descriptor in accordance with the generation and the operation of the mashup service configured by coupling the events, and a context descriptor manager that manages an execution result of the mashup service by using the context descriptor.

When different IoT services affect one IoT device to allow operations of the one IoT device to cause results opposite to each other, the mashup service manager may analyze a causal relationship between events generating the different IoT services to sense a conflict of the one IoT device.

The entity management module may control, based on to the analysis result, such that the operations of the IoT device causing the results opposite to each other are performed in a predetermined order of priority.

The context descriptor manager may generate a context descriptor representing an input and an output of the events generating the IoT service and an analysis result of the mashup service manager, and wherein the context descriptor may represent causes, statuses, and results of the events.

The mashup service manager may transfer an event to the service process queue manager when an event trigger condition is established such that the service process queue manager executes the event, and, wherein, when the operations of the IoT device cause results opposite to each other, the mashup service manager may sense an event causing a conflict of an IoT device.

The mashup service manager may obtain a list of events that generate the conflict of the IoT device to generate an event trace stack for each event.

The apparatus may store a precedence event in the event trace stack through comparison between the events, may store the precedence event in the event trace stack after analyzing the context descriptor of the precedence event, and may repeat processes from the process of generating the event trace stack until all events in the list are processed.

An event chain may be formed based on an output order of the event trace stack through the context descriptor manager after completing the generation of the event trace stack for the list of events.

When different IoT services affect one IoT device to allow operations of the one IoT device to cause results opposite to each other, the data management module may store an analysis result of the causal relationship between the events that generate the IoT service represented by using a context descriptor.

When different IoT services affect one IoT device to allow operations of the one IoT device to cause results opposite to each other, the visualization module may show, to the user, an analysis result of the causal relationship between the events that generate the IoT service represented by using a context descriptor.

Another aspect of embodiments of the inventive concept is directed to provide a method of managing an Internet-of-things (IoT) service. The method includes managing, through a service management module, a causal relationship between events that generate an IoT service to form an IoT service chain, and a generation and an operation of a mashup service configured by coupling a plurality of events, managing, through a data management module, an external service used by a user or provided by IoT devices and data input from a gateway, managing, through an entity management module, the IoT devices, the IoT service, and a user terminal which are registered in a server based on the event and the data in conjunction with each other, and controlling operations of the IoT devices based on the IoT service, and displaying, through a visualization module, a user interface required for the user to use the IoT service registered in the server.

The managing of the causal relationship between the events, and the generation and the operation of the mashup service may include generating, registering and managing the mashup service, and transferring the registered mashup service to a service process queue manager by a mashup service manager when a start event occurs; managing, by the service process queue manager, a service queue to be executed by a related event instance among the registered mashup services and executing a mashup service generated first in time sequence; managing, by a context descriptor manager, an execution result of the mashup service by using a context descriptor; and storing, by a context repository, the causal relationship between the events, and the context descriptor in accordance with the generations and the operations of the mashup services configured by coupling the events.

The transferring of the registered mashup service to the service process queue manager may include, when different IoT services affect one IoT device to allow operations of the one IoT device to cause results opposite to each other, analyzing, by the mashup service manager, a causal relationship between events generating the different IoT services to sense a conflict of the one IoT device.

The controlling of the operations of the IoT devices may include controlling based on to the analysis result such that the operations of the IoT device that cause the results opposite to each other are performed in a predetermined order of priority.

The managing of the execution result of the mashup service may include generating a context descriptor representing an input and output of the events generating the IoT service and an analysis result of the mashup service manager, and wherein the context descriptor may represent causes, statuses, and results of the events.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIGS. 1A to 1D are views illustrating an example of an operation of a registered IoT device for a registered IoT service according to an embodiment of the present invention;

FIGS. 2A and 2B are views illustrating exemplary cases that mutually different IoT services affect one IoT device to allow operations of the one IoT device to cause results opposite to each other;

FIG. 3 is a view illustrating an environment of an overall system for managing an IoT service according to an embodiment of the present invention;

FIG. 4 is a block diagram illustrating a configuration of an apparatus for managing an IoT service according to an embodiment of the present invention;

FIG. 5 is a view illustrating an example of sensing a cause of the conflict between IoT device operations by using a context descriptor according to an embodiment of the present invention;

FIG. 6 is a view illustrating generation of a context descriptor according to an embodiment of the present invention;

FIGS. 7 to 9 are views illustrating an example of a record of an operation of sensing an event conflict according to an embodiment of the present invention;

FIG. 10 is a view illustrating a method of forming an IoT service chain according to an embodiment of the present invention;

FIGS. 11A and 11B are views illustrating an example of notification of a conflict between operations of an IoT device according to an embodiment of the present invention;

FIG. 12 is a flowchart illustrating a method of managing an IoT service according to an embodiment of the present invention; and

FIG. 13 is a flowchart illustrating a process of managing the generation and operation of a mashup service according to an embodiment of the present invention.

### DETAILED DESCRIPTION

Hereinafter, embodiments of the present invention will be described in detail with reference to accompanying drawings.

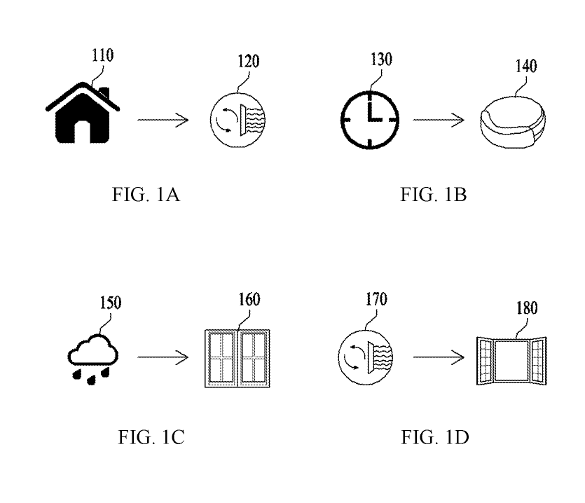

FIGS. 1A to 1D are views illustrating an example of an operation of a registered IoT device for a registered IoT service according to an embodiment of the present invention.

Referring to FIG. 1A, there is shown a registered first IoT service. The first IoT service is an IoT service that provides a ventilator operation 120 in a case 110 that a lot of dust exists in a house.

Referring to FIG. 1B, there is shown a registered second IoT service. The second IoT service is an IoT service that provides an automatic cleaning function by driving 140 a robot cleaner at predetermined time 130.

Referring to FIG. 1C, there is shown a registered third IoT service. The third IoT service is an IoT service that provides window closing 160 when it is raining 150.

Referring to FIG. 1D, there is shown a registered fourth IoT service. The fourth IoT service is an IoT service that provides window opening 180 when a ventilator is driven 170.

As described above, a desired service operation may be automatically performed according to an environment or a user's request.

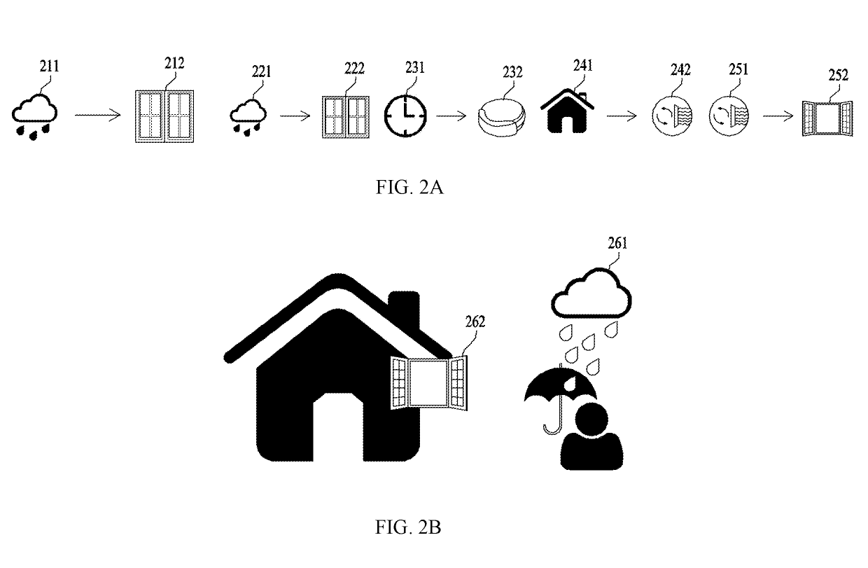

FIGS. 2A and 2B are views illustrating exemplary cases that mutually different IoT services affect one IoT device to allow the operations of the one IoT device to cause results opposite to each other.

For example, referring to FIG. 2A, when it is raining 211, there may be provided a window closing 212 service. However, when it is raining 221, the window closing 222 service may be provided and at the same time, an automatic cleaning function may be provided by driving 232 a robot cleaner at predetermined time 231 as shown in FIG. 2B. Thus, it is assumed that, since dust is increased 241, a ventilator 242 is operated, so that window opening 252 is provided. In this case, the operation of closing a window since it rains and the operation of opening a window since a ventilator is operated contradict each other. Although it is raining 261, a window may be opened 262.

Since the user may only see the final result of operated services, there is no way to easily know which service operations cause the result during processes.

Therefore, there are proposed a method and an apparatus for enabling a user to manage services in an environment that IoT services are operated in conjunction with each other. More particularly, there are proposed a method and an apparatus which show which services result in an execution result of an IoT service in order to solve the problems that services of an IoT service chain are operated in undesired forms or cause results opposite to each other.

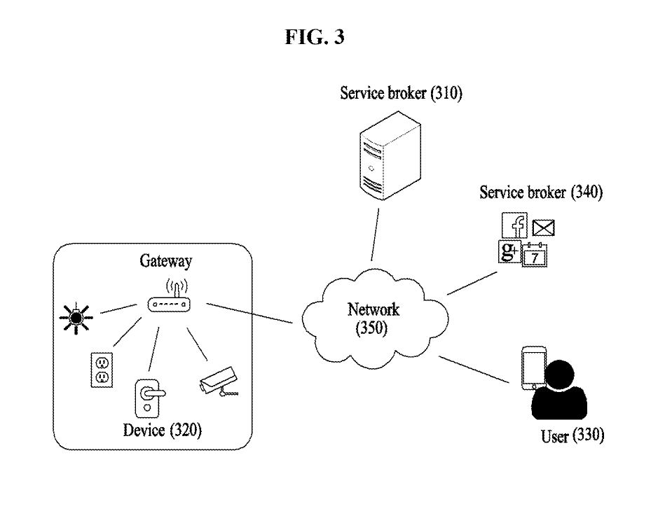

FIG. 3 is a view illustrating an environment of an overall system for managing an IoT service according to an embodiment of the present invention.

The system for managing an IoT service includes an apparatus 310 for managing an IoT service (in other words, a service broker), IoT devices (in other words, devices) 320, a user terminal (user) 330, an external service (3^{rd} party service) 340. In addition, the system for managing an IoT service further includes a network 350 connecting those, and a gateway connecting the IoT devices 320 to the network 350.

A server of the apparatus 310 for managing an IoT service (in other words, service broker) manages services (such as a generation, a delete, a change, and the like) related to the IoT device 320 connected thereto through the network 350 and provides a UI for a user.

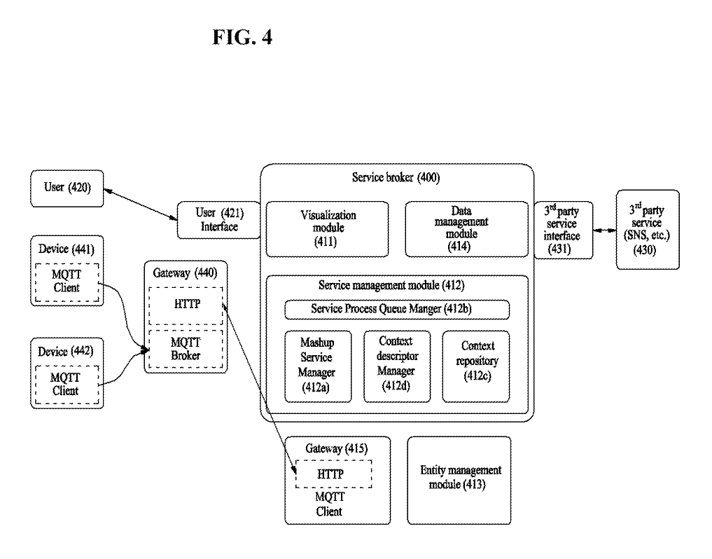

If necessary, the apparatus is also responsible for interworking with the external service (third party service) 340. Hereinafter, the apparatus 310 for managing an IoT service (service broken will be described in detail with reference to FIG. 4.

The IoT devices 320 are connected to the network 350 through the gateway and periodically exchange data and control commands with the server of the apparatus 310 for managing an IoT service (service broker) through communication with the server.

The user terminal (user) 330 accesses to the server of the apparatus 310 for managing an IoT service (service broker) to use IoT devices that he/she owns and the corresponding IoT services.

The external service (third party service) 340 refers to external services that the user is using or that is provided by IoT device manufacturers.

The gateway connecting the IoT devices 320 to the network 350 is responsible for connections between the IoT devices 320 and with an outside.

FIG. 4 is a block diagram illustrating a configuration of an apparatus for managing an IoT service according to an embodiment of the present invention.

An apparatus 400 for managing an IoT service includes a visualization module 411, a service management module 412, an entity management module 413, a data management module 414, and a gateway interface 415. In addition, the apparatus 400 for managing an IoT service further includes a user interface 421 connected to a user terminal (user) 420 and an external service interface (third party service interface) 431 connected to an external service (third party service 430.

A gateway 440 connects the gateway interface 415 of the apparatus 400 for managing an IoT service and a plurality of IoT devices 441 and 442 to each other by using HTTP and MQTT client.

The visualization module 411 is a module for displaying a user interface provided to allow a user to easily use a service.

The service management module 412 is a module for managing events generated by registered services. The service management module 412 manages a causal relationship between events generated by an IoT service, and the generation and operation of a mashup service configured by coupling a plurality of events in order to form an IoT service chain.

The service management module 412 includes a mashup service manager 412a, a service process queue manager 412b, a context repository 412c, and a context descriptor manager 412d.

The mashup service manager 412a generates the mashup service, and registers and manages the mashup service. When a start event occurs, the mashup service manager 412a transfers the registered mashup service to the service process queue manager 412b.

When different IoT services affect one IoT device to allow operations of the one IoT device to cause results opposite to each other, the mashup service manager 412a analyzes the causal relationship between events generating the different IoT services to sense a conflict of the one IoT device.

Thereafter, the entity management module 413 controls, based on to the analysis result, such that the operations of the IoT device causing the results opposite to each other are performed in a predetermined order of priority.

The service process queue manager 412b manages a service queue to be executed by a related event instance among registered mashup services and manages a mashup service generated first in time sequence to be executed.

The context repository 412c stores the causal relationship between the events, and a context descriptor in accordance with the generation and operation of the mashup service configured by coupling the events.

The context descriptor manager 412d manages an execution result of the mashup service by using the context descriptor. The context descriptor manager 412d generates a context descriptor representing an input and an output of the events generating the IoT service and an analysis result of the mashup service manager, and represents causes, statuses, and results of the events,

Hereinafter, the operation of the service management module 412 according to an embodiment of the present invention will be described in more detail. First, the mashup service manager 412a transfers an event to the service process queue manager 412b when an event trigger condition is established. The service process queue manager 412b executes the received event and when the operations of the IoT device cause the results opposite to each other, the mashup service manager 412a senses the event causing the conflict of the IoT device.

The mashup service manager 412a obtains a list of events that cause the conflict of the IoT device in the above-described manner and generates an event trace stack for each event. The mashup service manager 412a stores a precedence event in the event trace stack through comparison between the events, and stores the precedence event in the event trace stack after analyzing the context descriptor of the precedence event. Then, the above-described processes are repeated from the process of generating the event trace stack until all events in the list are processed.

After completing the generation of the event trace stack for the list of event chain is formed in an output order of the event trace stack through the context descriptor manager 412d.

In other words, the service management module 412 generates the context descriptor representing the inputs and outputs of the events by which the IoT services are generated, and the context descriptor represents the causes, statuses and results of the events.

Such a context descriptor connects the structure of IFTTT (If this than that) in an IoT service chain form, and defines the structure of IFTTT as an input/output interface of a device or a virtual object corresponding to “this” and “that” (for example, MQTT client as Publish and Subscribe).

Referring to FIG. 1 again, in cases of the first IoT service of FIG. 1A and the fourth IoT service of FIG. 1D, since the first and fourth IoT services are connected to each other through the ventilator which is a common IoT device, the causal relationship between the IoT services may be known.

In cases of the third IoT service of FIG. 1C and the fourth IoT service of FIG. 1D, since the IoT device on which the third and fourth IoT services exert an influence is a window, the conflict between both IoT services may be expected.

In cases of the second IoT service of FIG. 1B and the first IoT service of FIG. 1A, since any direct connections do not exist between both services, a data structure through which a chain of the services are known is required. In other words, a connecting link such as an attribute or a sensor device which may affect the results of the IoT services and may connect two different IoT services to each other is required. To this end, there is proposed the context descriptor.

The context descriptor describes an input and an output of an event.

The output of an event describes a situation changed as a result of the event. For example, as the result of an event ‘closing of window when it rains’, the output of the event may describe ‘closing of window’. In addition, as the result of an event ‘opening of window when ventilator is operated’, the output may describe ‘opening of window’.

The input of an event may describe an input situation of the event. For example, in the case of an event which is triggered by a sensor input value, the input of an event may describe ‘increasing of room dust concentration’ and ‘it rains’.

The definition of the context descriptor may include a cause, a status (context) and a result (effect).

The cause may represent an event or a functional operation of the IoT device caused by the event. For example, the cause may represent ‘operation of air cleaner’, ‘opening of window’, etc.

The context may represent an attribute which may be measured by a system changed by the cause. For example, the context may represent ‘room temperature’, ‘room dust concentration’, ‘humidity’, ‘window opening/closing state’, and the like.

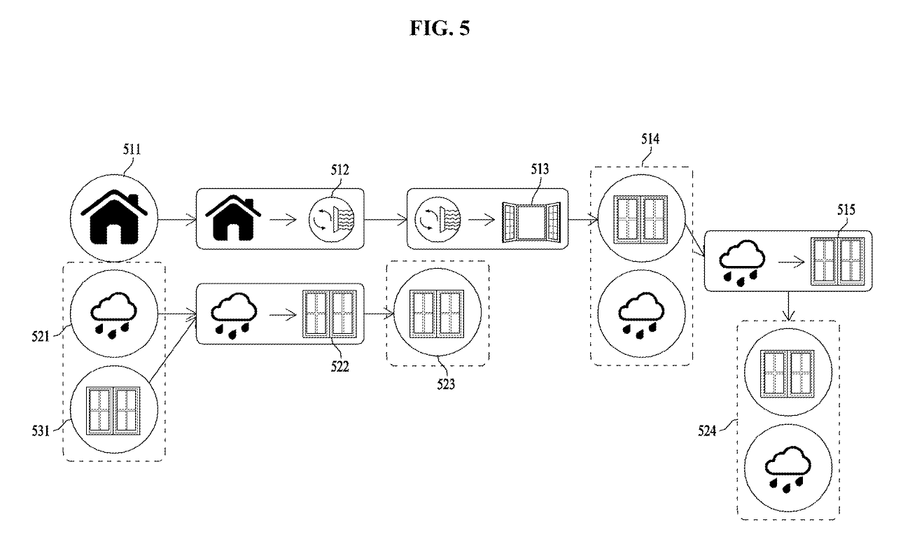

The result (effect) may represent a vector direction changed by the cause. For example, the effect may represent ‘room temperature rise’, ‘decrease of room dust’, ‘opening of window’, ‘increase of outdoor humidity’, and the like. The effect will be described in more detail with reference to FIG. 5.

The entity management module 413 manages the IoT devices, the IoT service, and a user terminal which are registered in the server based on the events and the data in conjunction with each other, and controls operations of the IoT devices based on the IoT service.

When different IoT services affect one IoT device such that the operations of the one IoT device cause results opposite to each other, the entity management module 413 controls, based on the analysis result of the service management module 412, such that the operations of the IoT device causing the results opposite to each other are performed in a predetermined order of priority.

The data management module 414 manages an external service used by the user or provided by the IoT devices and data input from the gateway.

When different IoT services affect one IoT device to allow the operations of the one IoT device to cause results opposite to each other, the data management module 414 stores an analysis result of the causal relationship between the events which generate the IoT service represented by using the context descriptor.

When different IoT services affect one IoT device to allow the operations of the one IoT device to cause results opposite to each other, the visualization module 411 shows, to the user, the analysis result of the causal relationship between the events that generate the IoT service represented by using a context descriptor.

FIG. 5 is a view illustrating an example of sensing a cause of the conflict between IoT device operations by using the context descriptor according to an embodiment of the present invention.

Referring to FIG. 5, when a lot of dust exists in a house 511, there is provided a ventilator operation 512. When the ventilator is operated 512, there is provided a window opening 513. In a state that the window is opened, when it rains 514, there is provided a window closing 515.

According to another embodiment, when it rains 521 and the window is opened 531, there is provided the window closing 522. As described above, when the ventilator operation 512 is provided in the state that the window is closed 523, the window opening service 513 and the window closing service 523 contradicts each other. Thus, the operation to close the window because it rains and the operation to open the window because the ventilator is operated contradict each other, so that the case 524 that the window is opened may occur although it rains.

Thus, the cause of the conflict between IoT device operations may be visually sensed through a specific context descriptor.

The mashup service according to an embodiment of the present invention is formed by coupling a plurality of events. One mashup service includes an event instance that triggers the corresponding mashup service, a condition that is a condition statement of processing events, and an action instance that represents the operation of the corresponding mashup service, as shown below. In this case, the input event instance may include a plurality of event instances.

{
id: ID for specifying service
event_instances: [<Instance>],
action_instance: <Instance>,
conditions: <runnable script>
}

Wherein [ ] is a symbol that indicates an array and may have 1 to N elements. <runnable script> represents a program code part necessary for the actual operation. <runnable script> may be applied without limiting any languages (e.g., Javascript, etc.).

A basic instance constituting the mashup service is a unit that may be connected to an actual IoT device or a unit service, and is configured as follows.

{
id: ID for specifying instance,
type: kind of instance,
target: <runnable script>
behavior: <runnable script>
context: [<Context>]
}

Wherein the behavior is a code that may specify the operations of a device and a service, the target is an interface code that may interact with a device and a service, and the context represents contexts that may exert an influenced by operating an instance. One instance may include several operations and may specify a context based on an operation.

When an actual instance is operated, the operated context of the instance defines an element that may exert an influence on contexts and may be configured as follows.

```
          {
          id: context id,
          context: attribute that may be measured and changed based
on operations of instances
          direction: change direction of corresponding context
          }
```

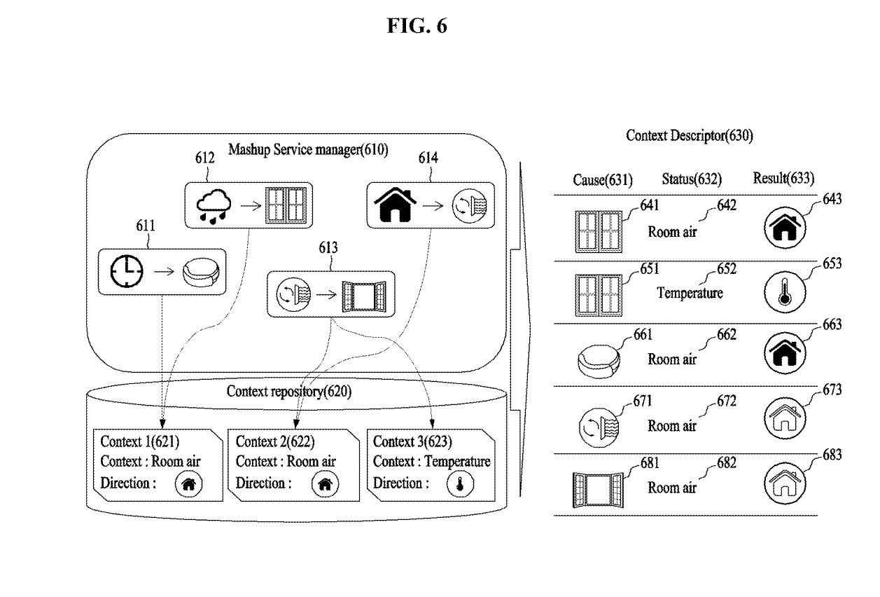

FIG. 6 is a view illustrating generation of a context descriptor according to an embodiment of the present invention.

A mashup service manager 610 transfers an event to a service process queue manager when an event trigger condition is established. A first event 611 is to operate the robot cleaner at predetermined time, and a second event 612 is to dose the window when it rains. A context 1 621 about the worse room air due to the first event 611 and the second event 612 has been stored in a context repository 620.

A third event 613 is to open the window when the ventilator is operated. The context 1 621 for the room air that is comfortable due to the third event is stored in the context repository 620. In addition, a context 3 623 about the rise of the room temperature due to the third event has been stored in the context repository 620.

A fourth event 614 is to operate the ventilator when room air is bad. A context 2 622 about the room air being comfortable due to the fourth event has been stored in the context repository 620.

The context descriptor 630 representing the causes, status, and result of the context corresponding to the event described above will be described below.

A first context descriptor may represent a process of causing a result 633 of increasing the dust 643 due to a cause 631 of window closing 641 as a state 632 of room air 642.

A second context descriptor may represents a process of causing a result 633 of rising temperature due to a cause 631 of window closing 651 as a state 632 of temperature 652.

A third context descriptor may represents a process of causing a result 633 of increasing dust 663 due to a cause 631 of robot cleaner operating 661 as a state 632 of room air 662.

A fourth context descriptor may represents a process of causing a result 633 of comfortable room air 673 due to a cause 631 of an operation 671 of a ventilator as a state 632 of room air 672

A fifth context descriptor may represents a process of causing a result 633 of comfortable room air 683 to a cause 631 of window opening 681 as a state 632 of room air 682.

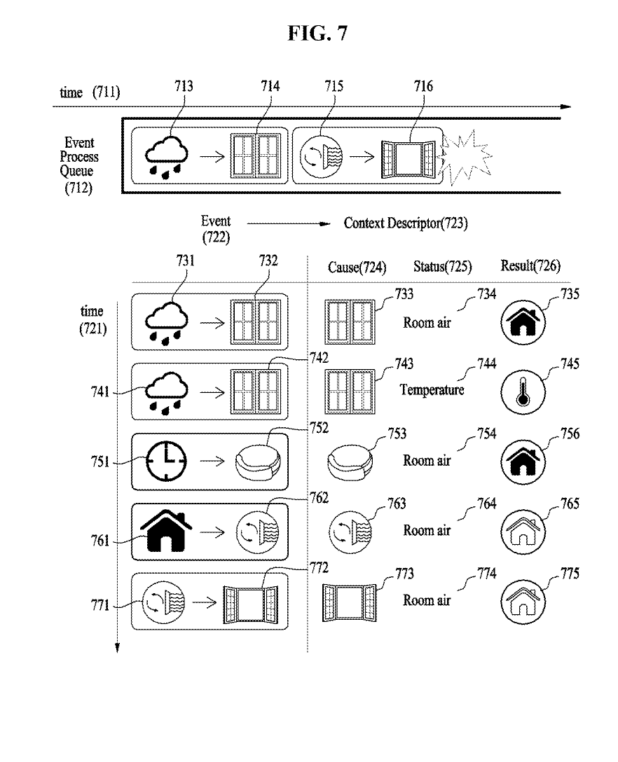

FIGS. 7 to 9 are views illustrating an example of a record of an operation of sensing an event conflict according to an embodiment of the present invention.

Referring to FIG. 7, the context descriptor may record an event conflict sensing operation over time 711. A collection of currently operating IoT services may be represented through an event process queue 712.

As a current state, it rains 713, so that window closing 714 has been provided and at the same time, window opening 716 has been provided through ventilator operating 715. In this case, it is represented in the event process queue 712 that IoT services of window closing 714 and window opening 716 which contradict each other are operated

Referring to FIG. 7, all service collections including currently executed events 751 and 761 and execution completed events 741, 751 and 771 are shown in time sequence 721.

As a state 725 of room air 734, a process of causing a result 726 of dust increase 735 due to a cause 733 of window closing 733 may be represented through the context descriptor 723 about an event 722 for providing window closing 732 in a case 734 that it rains.

As a state 725 of temperature 744, a process of causing a result 726 of temperature increase 745 due to the cause 733 of window closing 743 may be represented through the context descriptor 723 about the event 722 for providing window closing 732 in a case 734 that it rains.

As a state 725 of room air 754, a process of causing a result 726 of dust increase 755 due to a cause 733 of robot cleaner operating 743 may be represented through the context descriptor 723 about the event 722 for providing an automatic cleaning function by operating a robot cleaner 752 at predetermined time 751.

As a state 725 of room air 764, a process of causing a result 726 of comfortable room air 765 due to the cause 733 of ventilator operating 763 may be represented through the context descriptor 723 about the event 722 for providing ventilator operating 762 in a case 761 that a lot of dust exists in a house.

As a state 725 of room air 774, a process of causing a result 726 of comfortable room air 765 due to the cause 733 of window opening 773 may be represented through the context descriptor 723 about the event 722 for providing window opening 772 by operating the ventilator 771.

In this case, one event may have one or more context descriptors 723.

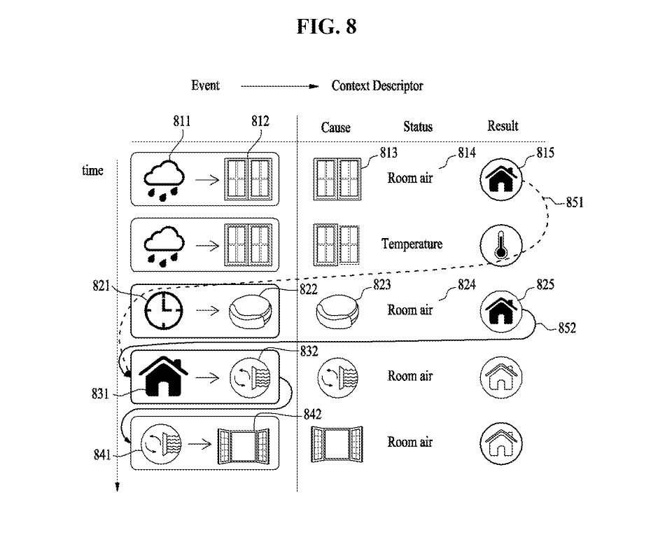

Referring to FIG. 8, as a state of room air 814, a process of causing a result of dust increase 815 due to window closing 813 may be represented through the context descriptor about an event for providing window closing 812 in a case 811 that it rains.

In addition, as a state of room air 824, a process of causing a result of dust increase 825 due to a cause of robot cleaner operating 823 may be represented through the context descriptor about an event for providing an automatic cleaning function by operating a robot cleaner 822 at predetermined time 821.

For this reason, the dust is increased in a house 831 so that the ventilator may be operated 832, and the ventilator is operated 841 so that the winding opening 842 may be provided.

In this case, according to the context descriptor, there are two possibilities 851 and 852. When the operations of the IoT device overlap each other like this, an event that occurs later may be first connected. The priority in time is only an embodiment, and a user may arbitrarily set a desired priority.

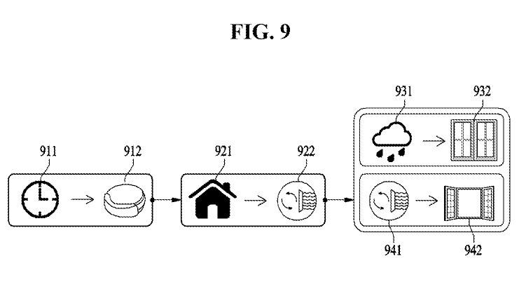

Referring to FIG. 9, an analysis result using a context descriptor may be represented through a user interface.

The automatic cleaning function may be provided by operating 912 the robot cleaner at predetermined time 911 and dust may be increased 921 in room air due to the robot cleaner operation 912, so that the ventilator operating 922 is provided. In addition, due to the ventilator operating 941, the window opening 942 may be provided. At this case, if it rains 931, the conflict between the window closing 932 and opening 942 services may occur. The analysis result using the context descriptor about the conflict between the operations of the IoT device may be shown through the user interface.

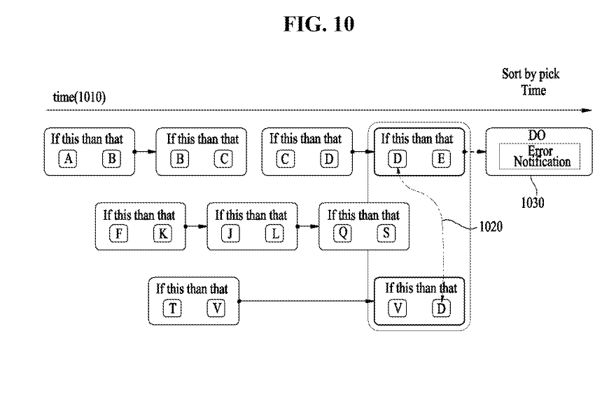

FIG. 10 is a view illustrating a method of forming an IoT service chain according to an embodiment of the present invention.

An IoT service chain connects the structure of IFTTT (If this than that) in a chain form, and defines the structure of IFTTT as a device corresponding to “this” and “that” or an input/output interface of a virtual object (for example, MQTT client as Publish and Subscribe) (may be shown, for example, in an icon shape on an UI).

A monitoring object may include chaining and timing. The chaining is performed when a loop occurs on Publish and Subscribe. The timing may be performed when two or more events of Publish and Subscribe occur within a predetermined time period, or since the predetermined time period may be changed depending on characteristics of a user, the timing is learned based on event log information.

Referring to FIG. 10, an example of connecting the structure of IFTTT in the chain form is shown. If A, B operation is provided, and if B, C operation is provided. If C, D operation is provided, and if D, E operation is provided. If F, K operation is provided, and if F becomes J due to K, L is provided. If F becomes Q due to L, S is provided. If T, V is provided, and if V, D is provided. In this case, two routes affect D, and these conflicts may be represented through the user interface by an ‘Error Notification’ notification.

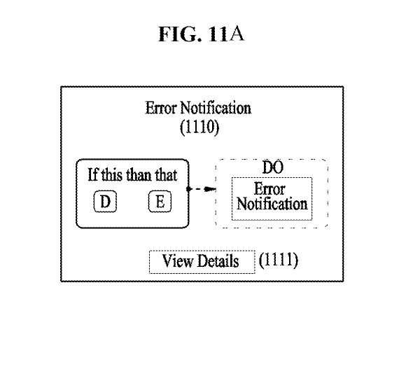

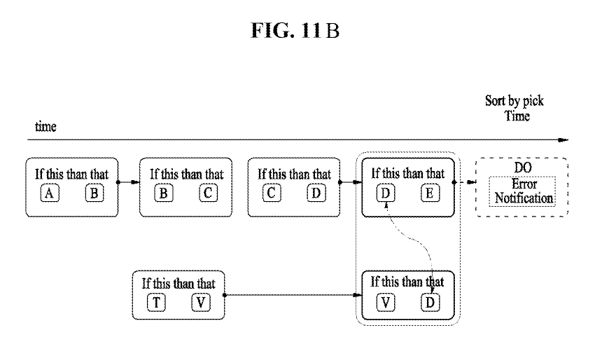

FIGS. 11A and 11B are views illustrating an example of notification of a conflict between operations of an IoT device according to an embodiment of the present invention.

As illustrated in FIG. 10, if C, D operation is provided, and if D, E operation is provided. In addition, if T, V is provided and if V, D is provided. In this case, two routes affect D, and as shown in FIG. 11A, the conflict may be represented through the user interface by an ‘Error Notification’ notification 1110. If ‘View Details’ 1111 in the ‘Error Notification’ notification 1110 is clicked, the context descriptor for the conflict between the operations of the IoT device is seen in more detail.

FIG. 11B illustrates the context descriptor about the conflict between the operations of the IoT device shown in more detail if clicked.

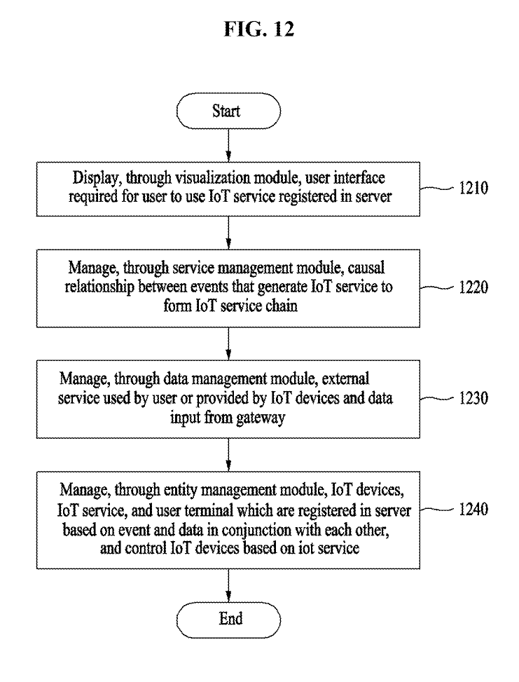

FIG. 12 is a flowchart illustrating a method of managing an IoT service according to an embodiment of the present invention.

A method of managing an IoT service includes operation 1210 of displaying, through a visualization module, a user interface required for a user to use the IoT service registered in the server, operation 1220 of managing, through a service management module, the causal relationship between events that generate an IoT service to form an IoT service chain, operation 1230 of managing, through a data management module, an external service used by the user or provided by IoT devices and data input from a gateway, and operation 1240 of managing, through an entity management module, the IoT devices,the IoT service, and a user terminal which are registered in the server based on the event and the data in conjunction with each other.

In operation 1210, the user interface required for a user to use the IoT service registered in the server is displayed through the visualization module. When different IoT services affect one IoT device to allow the operations of the one IoT device to cause results opposite to each other, the analysis result of the causal relationship between the events that generate the IoT service represented by using a context descriptor is show to the user.

In operation 1220, the causal relationship between events that generate an IoT service to form an IoT service chain is managed through the service management module.

The service management module is a module for managing events generated by registered services. The service management module manages the causal relationship between events generated by an IoT service to form an IoT service chain.

When different IoT services affect one IoT device to allow the operations of the one IoT device to cause results opposite to each other, the service management module analyzes the causal relationship between the events that generate the different IoT services.

In addition, the service management module generates the context descriptor and records the conflict sensing operations of the IoT device in the data management module by using the context descriptor.

The service management module generates the context descriptor representing the input and output of the events that generate the IoT service, and the context descriptor represents the causes, statuses, and results of the events.

The context descriptor connects the structure of IFTTT (If this than that) in an IoT service chain form, and defines the structure of IFTTT as an input/output interface of a device or a virtual object corresponding to “this” and “that” (for example, MQTT client as a “Publish and Subscribe”).

In operation 1230, the external service used by the user or provided by IoT devices and the data input from the gateway are managed through the data management module. When different IoT services affect one IoT device to allow the operations of one IoT device to cause results opposite to each other, the data management module stores the analysis result of the causal relationship between the events that generate the IoT service represented by using the context descriptor.

In operation 1240, the IoT devices, the IoT service, and the user terminal which are registered in the server based on the event and the data in conjunction with each other are managed through the entity management module, and the operations of the IoT devices are controlled based on the IoT service.

When different IoT services affect one IoT device to allow the operations of the one IoT device to cause results opposite to each other, the entity management module 413 controls based on to the analysis result of the service management module 412 such that the operations of the IoT device that cause the results opposite to each other are performed in the predetermined order of priority.

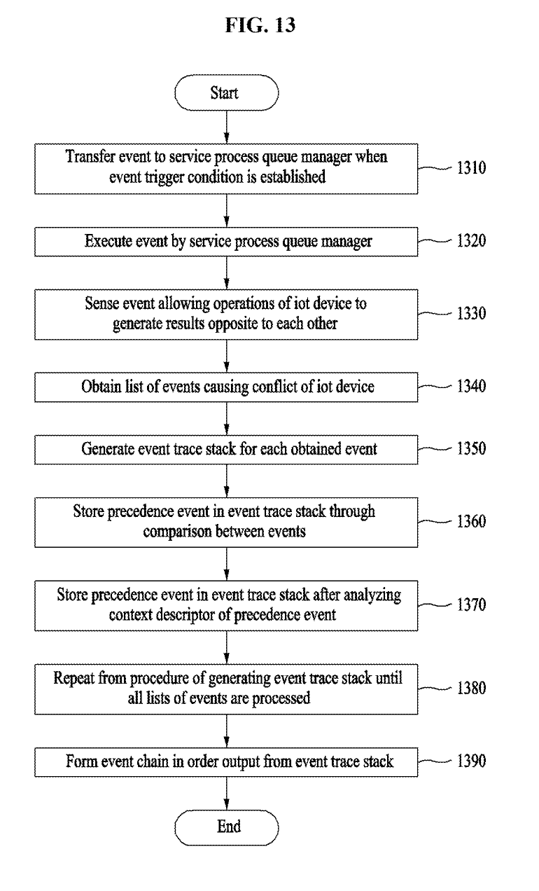

FIG. 13 is a flowchart illustrating a process of managing the generation and operation of a mashup service according to an embodiment of the present invention.

An IoT service chain is formed by managing the causal relationship between events that generate an IoT service, and the generation and operation of a mashup service configured by coupling a plurality of events, through the service management module including the mashup service manager, the service process queue manager, the context repository, and the context descriptor manager.

In operation 1310, the mashup service manager generates, registers and manages the mashup service, and transfers an event to the service process queue manager when a start event occurs and an event trigger condition is established.

In operation 1320, the service process queue manager manages a service queue to be executed by a related event instance among registered mashup services and manages a mashup service generated first in time sequence to be executed.

In operation 1330, when different IoT services affect one IoT device to allow operations of the one IoT device to cause results opposite to each other, the mashup service manager senses an event causing the conflict of an IoT device.

In operation 1340, the mashup service manager obtains the list of events that cause the conflict of the IoT device.

In operation 1350, an event trace stack for each of the obtained events is generated. In operation 1360, a precedence event is stored in the event trace stack through comparison between the events. After the context descriptor of the precedence event is analyzed in operation 1370, the event is stored in the event trace stack. The operations are repeated from the operation of generating the event trace stack until all lists of events are processed, in operation 1380.

After the generation of the event trace stack for the list of events is completed, in operation 1390, an event chain is formed in the output order of the event trace stack through the context descriptor manager.

According to an embodiment of the present invention, a problem of a circular reference call to the IoT service chain may be sensed by using a mashup service. An existing mashup service, such as IFTTT or instance hosting, could not sense infinite repetition of services by circular reference between services (for example, A→B→C→A→B→C→ . . . ). Meanwhile, according to the present invention, which operations of services cause the result of execution of an IoT service may be analyzed, thereby solving the problems that services are operated in undesired forms or several services cause results opposite to each other. In addition, corresponding information may be visualized and is configured in an API form. To this end, an interface is provided to be combined with a notification service for application.

Since the scalability of the mashup service is flexible, the present invention may be applicable to many IoT application environments with such a Pub/Sub processing structure. For example, the present invention is applicable not only to a small-scale environment such as a smart home, but also to a medium/large-scale system such as a smart factory using many sensors and actuators. In particular, the present invention is applicable not only to a server and a cloud-based IoT platform capable of large capacity processing, but also to a gateway-based solution such as instance hosting.

According to the embodiments of the present invention, it may be possible to represent which services result in an execution result of an IoT service in order to solve the problems that services of an IoT service chain are operated in undesired forms or cause results opposite to each other.

The foregoing devices may be realized by hardware elements, software elements and/or combinations thereof. For example, the devices and elements illustrated in the exemplary embodiments of the inventive concept may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A processing unit may implement an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one or more computer-readable storage media.

The methods according to the above-described exemplary embodiments of the inventive concept may be implemented with program instructions which may be executed through various computer means and may be recorded in computer-readable media. The media may also include, alone or in combination with the program instructions, data files, data structures, and the like. The program instructions recorded in the media may be designed and configured specially for the exemplary embodiments of the inventive concept or be known and available to those skilled in computer software. Computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter. The described hardware devices may be configured to act as one or more software modules to perform the operations of the above-described exemplary embodiments of the inventive concept, or vice versa.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Thus, it is intended that the inventive concept covers other realizations and other embodiments of this invention provided they come within the scope of the appended claims and their equivalents

What is claimed is:

1. An apparatus for managing an Internet-of-things (IoT) service, the apparatus comprising:
a visualization module configured to display a user interface required for a user to use an IoT service registered in a server;
a service management module configured to manage a causal relationship between events that generate the IoT service to form an IoT service chain, and a generation and an operation of a mashup service configured by coupling a plurality of events;
a data management module configured to manage an external service used by the user or provided by IoT devices and data input from a gateway;
an entity management module configured to manage the IoT devices, the IoT service, and a user terminal which are registered in the server based on the event and the data in conjunction with each other, and to control operations of the IoT devices based on the IoT service; and
a gateway interface configured to communicate with the gateway connected to the IoT devices.

2. The apparatus of claim 1, wherein the service management module includes:
a mashup service manager configured to generate, register and manage the mashup service, wherein, when a start event occurs, the mashup service manager transfers the registered mashup service to a service process queue manager;
the service process queue manager configured to manage a service queue to be executed by a related event instance among the registered mashup services and to manage a mashup service generated first in time sequence to be executed;
a context repository configured to store the causal relationship between the events, and a context descriptor in accordance with the generation and the operation of the mashup service configured by coupling the events; and
a context descriptor manager configured to manage an execution result of the mashup service by using the context descriptor.

3. The apparatus of claim 2, wherein, when different IoT services affect one IoT device to allow operations of the one IoT device to cause results opposite to each other, the mashup service manager analyzes a causal relationship between corresponding events generating the different IoT services to sense a conflict of the one IoT device.

4. The apparatus of claim 3, wherein the entity management module controls, based on to the analysis result, such that the operations of the IoT device causing the results opposite to each other are performed in a predetermined order of priority.

5. The apparatus of claim 2, wherein the context descriptor manager generates a context descriptor representing inputs and outputs of corresponding events generating IoT services, and an analysis result of the mashup service manager from a causal relationship between the corresponding events generating different IoT services, and
wherein the context descriptor represents causes, statuses, and results of the events.

6. The apparatus of claim 3, wherein the mashup service manager obtains a list of events that generate the conflict of the IoT device to generate an event trace stack for each event.

7. The apparatus of claim 6, wherein the apparatus analyzes a context descriptor of precedence event through comparison between events generating the conflict of the IoT device to store the context descriptor of the precedence event in the event trace stack, and repeats operations of analyzing and storing the context descriptor of the precedence event until all events included in the list of events generating the conflict of the IoT device are analyzed.

8. The apparatus of claim 7, wherein an event chain is formed through the context descriptor manager according to an output order of the event trace stack after the generation of the event trace stack for the list of events is completed.

9. The apparatus of claim 1, wherein, when different IoT services affect one IoT device to allow operations of the one IoT device to cause results opposite to each other, the data management module stores an analysis result of a causal relationship between corresponding events that generate the different IoT services through the service management module by using a context descriptor.

10. The apparatus of claim 1, wherein, when different IoT services affect one IoT device to allow operations of the one la device to cause results opposite to each other, the visualization module shows, to the user, an analysis result of the causal relationship between corresponding events that generate the different IoT services through the service management module by using a context descriptor.

11. A method of managing an Internet-of-things (IoT) service, the method comprising:
displaying, through a visualization module, a user interface required for a user to use an IoT service registered in a server;
managing, through a service management module, a causal relationship between events that generate an IoT service to form an IoT service chain, and a generation and an operation of a mashup service configured by coupling a plurality of events;
managing, through a data management module, an external service used by the user or provided by IoT devices and data input from a gateway; and
managing, through an entity management module, the IoT devices, the IoT service, and a user terminal which are registered in the server based on the event and the data in conjunction with each other, and controlling operations of the IoT devices based on the service:

12. The method of claim 11, wherein the managing of the causal relationship between the events, and the generation and the operation of the mashup service includes:
generating, registering and managing the mashup service, and transferring the registered mashup service to a service process queue manager by a mashup service manager when a start event occurs;
managing, by the service process queue manager, a service queue to be executed by a elated event instance among the registered mashup services and executing a mashup service generated first in time sequence;
managing, by a context descriptor manager, an execution result of the mashup service by using a context descriptor; and
storing, by a context repository, the causal relationship between the events, and the context descriptor in accordance with the generations and the operations of the mashup services configured by coupling the events.

13. The method of claim 12, wherein the transferring of the registered mashup service to the service process queue manager includes,
when different IoT services affect one IoT device to allow operations of the one IoT device to cause results opposite to each other, analyzing, by the mashup service manager, a causal relationship between corresponding events generating the different IoT services to sense a conflict of the one IoT device.

14. The method of claim 13, wherein the controlling of the operations of the IoT devices includes:
controlling based on to the analysis result such that the operations of the IoT device that cause the results opposite to each other are performed in a predetermined order of priority.

15. The method of claim 14, wherein the managing of the execution result of the mashup service includes:
generating a context descriptor representing inputs and outputs of corresponding events generating IoT services, and an analysis result of the mashup service manager from a causal relationship between the corresponding events generating different IoT services, and
wherein the context descriptor represents causes, statuses, and results of the events.

16. The method of claim 13, further comprising: obtaining a list of events that cause the conflict of the IoT device to generate an event trace stack for each event through the mashup service manager.

17. The method of claim 16, further comprising:
analyzing a context descriptor of a precedence event through comparison between the events generating the conflict of the IoT device and storing an analysis result in the event trace stack; and
repeating operations the analyzing and storing of the context descriptor of the precedence event until all events included in the list of events generating the conflict of the IoT device are analyzed

18. The method of claim 17, further comprising:
forming an event chain through the context descriptor manager according to an output order of the event trace stack after the generation of the event trace stack for the list of events is completed.
